(19) United States
(12) Patent Application Publication
(10) Pub. No.: US 2004/0013067 A1
(43) Pub. Date: Jan. 22, 2004

(54) Information storage medium and method of recording and/or reproducing data thereon

(75) Inventors: Kyung-Geun Lee, Gyeonggi-do (KR); In-Sik Park, Gyeonggi-do (KR); Du-Seop Yoon, Gyeonggi-do (KR); Jae-Seong Shim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/600,330

(22) Filed: Jun. 23, 2003

Related U.S. Application Data
(60) Provisional application No. 60/433,968, filed on Dec. 18, 2002.

(30) Foreign Application Priority Data
Jun. 29, 2002 (KR) 2002-37521
Dec. 17, 2002 (KR) 2002-80878

(51) Int. Cl. G11B 7/00

(52) U.S. Cl. 369/53.22; 369/275.3; 369/94

(57) ABSTRACT

In an information storage medium, information about a user data area where user data is recorded is recorded in at least one of an area right before and an area right after a basic recording unit of the user data area. In a method of recording and/or reproducing data with respect to an information storage medium, information about a user data area where user data is recorded is read from at least one of two areas right before and after the user data area, and the user data area is recognized using the read information.

### CROSS-REFERENCE TO RELATED APPLICATIONS

This application claims the benefit of U.S. Provisional Application No. 60/433,968 filed on Dec. 18, 2002, and Korean Patent Application Nos. 2002-37521 and 2002-80878, filed on Jun. 29, 2002 and Dec. 17, 2002, respectively, in the Korean Intellectual Property Office, the disclosures of which are incorporated herein by reference.

### BACKGROUND OF THE INVENTION

1. Field of the Invention

The present invention relates to an information storage medium and a method of recording and/or reproducing data thereon, and more particularly, to an information storage medium in which information about a user data area is recorded on an inside and/or outside of a basic recording unit of the user data area, and a method of recording and/or reproducing data on the information storage medium.

2. Description of the Related Art

Generally, optical disks are widely used as information storage media for optical pickup apparatuses to record/reproduce information in a non-contact manner. Optical disks include compact disks (CDs) or digital versatile disks (DVDs) according to their information storage capacity. Examples of recordable optical disks are a 650 MB CD-R, a CD−RW, and a 4.7 GB DVD+RW. Furthermore, HD-DVDs having a recording capacity of 20 GB or more are under development.

FIG. 1 shows a conventional optical disk having a lead-in area (B), a user data area (A), and a lead-out area (C), which are sequentially formed from an inner boundary Rᵢₙ to an outer boundary Rₒᵤₜ of the optical disk. In the optical disk, the number of sector addresses increases from the inner boundary Rᵢₙ to the outer boundary Rₒᵤₜ. The user data area A includes a plurality of error correction code (ECC) blocks.

FIG. 2 illustrates that information about the address of each ECC block is recorded as a groove wobble in a recordable optical disk because data may be randomly recorded or reproduced regardless of the sequence of physical addresses of basic recording units. In particular, where physical addresses are recorded as a groove wobble, information about a user data area is recorded as a groove wobble. However, the recordable optical disk has a layer and does not include layer information. It is difficult to keep consistency between the formats of the recordable optical disk and reproduction-only optical disks.

FIG. 3 shows that in a reproduction-only optical disk, each ECC block is comprised of a total of 16 sectors, from a zeroth to a fifteenth sector, and a sector address (SA) is recorded at a head of each of the sectors that constitute the ECC block. In other words, reproduction-only optical disks store information about user data, that is, address information, in the ECC blocks of a user data area.

In contrast to recordable optical disks, reproduction-only optical disks have no grooves in a user data area, which makes it necessary to record information about the user data area in a different way than in recordable optical disks.

Recordable optical disks and reproduction-only optical disks have been developed so as to have greater recording capacities. Recording capacity can be increased by shortening the wavelength of a recording optical source or by increasing the numerical aperture of an objective lens. However, recording capacity can also be increased by having a plurality of storage layers.

A DVD-ROM having a plurality of information storage layers is disclosed in U.S. Pat. No. 5,881,032.

FIG. 4A shows a sector address structure of a conventional optical disk having two information storage layers. Referring to FIG. 4A, the optical disk includes first and second information storage layers L₁ and L₂. The first and second information storage layers L₁ and L₂ have lead-in areas 1a and 2a, respectively, and lead-out areas 1b and 2b, respectively. In the first information storage layer L₁, sector address numbers (X) increase from an inner boundary Rᵢₙ to an outer boundary Rₒᵤₜ. In the second information storage layer L₂, sector address numbers (X′) increase from the outer boundary Rₒᵤₜ to the inner boundary Rᵢₙ.

Multi-layer optical disks having at least two information storage layers are classified as opposite track path (OTP) type optical disks or parallel track path (PTP) type optical disks according to a direction in which information is reproduced. As shown in FIG. 4B, in OTP optical disks, a first information storage layer L₁ is first reproduced from an inner boundary Rᵢₙ to an outer boundary Rₒᵤₜ and then a second information storage layer L₂ is reproduced from the outer boundary Rₒᵤₜ to the inner boundary Rᵢₙ. In other words, track spiraling directions of the information storage layers L₁ and L₂ of the OTP optical disks are opposite.

FIG. 4C shows an OTP multi-layer optical disk having first through fourth information storage layers L₁, L₂, L₃, and L₄. The first through fourth information storage layers L₁, L₂, L₃, and L₄ have first through fourth lead-in areas 1a, 2a, 3a, and 4a, respectively, and first through fourth lead-out areas 1b, 2b, 3b, and 4b, respectively, so as to have lead-in and lead-out areas alternate in each of inner and outer boundary areas of the optical disk. Looking at the reproduction direction of the four-layer optical disk of FIG. 4C, the first information storage layer L₁ is first reproduced from an inner boundary Rᵢₙ to an outer boundary Rₒᵤₜ, the second information storage layer L₁ is then reproduced from the outer boundary Rₒᵤₜ to the inner boundary Rᵢₙ, the third information storage layer L₃ is then reproduced in a direction of from the inner boundary Rᵢₙ to the outer boundary Rₒᵤₜ, and the fourth information storage layer L₄ is then reproduced in a direction of from the outer boundary Rₒᵤₜ to the inner boundary Rᵢₙ.

FIG. 5 shows a PTP two-layer optical disk. Data is first reproduced from an inner boundary Rᵢₙ to an outer boundary Rₒᵤₜ of a first information storage layer L₁, and then reproduced from an inner boundary Rᵢₙ to an outer boundary Rₒᵤₜ of the second information storage layer L₂. In other words, the information storage layers of a PTP optical disk are reproduced in the same track spiraling direction. Here, the first information storage layer L₁ has a first lead-in area 1a at its inner boundary area and a first lead-out area 1b at its outer boundary area. Similarly, the second information storage layer L₂ has a second lead-in area 2a at its inner boundary area and a second lead-out area 2b at its outer boundary area.

The lead-in areas 1a, 2a, 3a, and 4a and the lead-out areas 1b, 2b, 3b, and 4b store information about the optical disk. Recordable optical disks also store various conditions of recording. Hence, a user data can only be properly recorded on or reproduced from an optical disk by reading information from the lead-in areas and the lead-out areas. In particular, information storage media having a plurality of information storage layers store information about the number of information storage layers in each information storage layer. Accordingly, information about the number of information storage layers can be detected from any information storage layer.

In recordable information storage media, information about information storage layers, which is necessary upon data recording, must be recorded in a user data area because data recording or reproduction may randomly occur regardless of the sequence of physical addresses of basic recording units. In particular, where the physical addresses are recorded as a groove wobble, the information about the information storage layers can also be recorded as a groove wobble. In this case, upon data recording or reproduction, the information about the information storage layers can be reproduced using a push-pull channel signal.

On the other hand, reproduction-only information storage media do not have groove wobbles formed on their user data area, which makes it necessary to record information about information storage layers in a different way than in recordable information storage media.

### SUMMARY OF THE INVENTION

Accordingly, it is an aspect of the present invention to provide an information storage medium in which information about a user data area is read using physical addresses of the user data area or read from areas right before and after a basic recording area unit of the user data area, and a method of recording and/or reproducing data on the information storage medium.

Additional aspects and/or advantages of the invention will be set forth in part in the description which follows and, in part, will be obvious from the description, or may be learned by practice of the invention.

To achieve the above and/or other aspects of the present invention, there is provided an information storage medium comprising a user data area, wherein information about the user data area, where user data is recorded, is recorded in at least one of an area right before and an area right after a basic recording unit of the user data area.

The basic recording unit of the user data area may be one of a physical cluster, an error correction code (ECC) block, a sector, and a frame.

The information about the user data area may be recorded in at least one of a run-in area and a run-out area that are right before and after the physical cluster, respectively.

The information storage medium may include at least two information storage layers, wherein the information about the user data area may be recorded in at least one of the area right before and the area right after the basic recording unit of the user data area in different patterns for different information storage layers.

To achieve the above and/or other aspects of the present invention, there is provided a method of recording and/or reproducing data on an information storage medium having a user data area, the method comprising reading information about the user data area, where, user data is recorded, from at least one of an area right before and an area right after a basic recording unit of the user data area, and recording and/or reproducing the data based on the information about the user data area.

### BRIEF DESCRIPTION OF THE DRAWINGS

These and/or other aspects and advantages of the invention will become apparent and more readily appreciated from the following description of the preferred embodiments taken in conjunction with the accompanying drawings in which:

FIG. 1 is a view illustrating a conventional single-layer optical disk;

FIG. 2 is a view illustrating an address structure of an ECC block of a conventional recordable optical disk;

FIG. 3 is a view illustrating an address structure of an ECC block of a conventional reproduction-only optical disk;

FIG. 4A is a view illustrating a sector address structure of a conventional two-layer DVD-ROM;

FIG. 4B is a view illustrating a configuration of lead-in and lead-out areas of a conventional opposite track path (OTP) type DVD-ROM having four information storage layers;

FIG. 4C is a view illustrating a configuration of lead-in and lead-out areas of a conventional OTP type DVD-ROM having four information storage layers;

FIG. 5 is a view illustrating a configuration of lead-in and lead-out areas of a conventional parallel track path (PTP) type DVD-ROM having two information storage layers;

FIG. 6 is a view illustrating a data structure of a lead-in area or a lead-out area of a recordable information storage medium related to the present invention;

FIG. 7 is a schematic view illustrating the entire structure of a reproduction-only information storage medium related to the present invention;

FIG. 8 is a flowchart illustrating a method of recording and/or reproducing data on an information storage medium, according to an embodiment of the present invention;

FIG. 9 is a flowchart illustrating a method of recording and/or reproducing data on an information storage medium, according to another embodiment of the present invention;

FIG. 10 is a view illustrating a basic user data area unit of an information storage medium according to an embodiment of the present invention, to which information about the user data area is recorded;

FIG. 11A is a view illustrating a recording area unit of an information storage medium according to the present invention; and

FIG. 11B is a view illustrating a sequence of a recording area unit according to present invention.

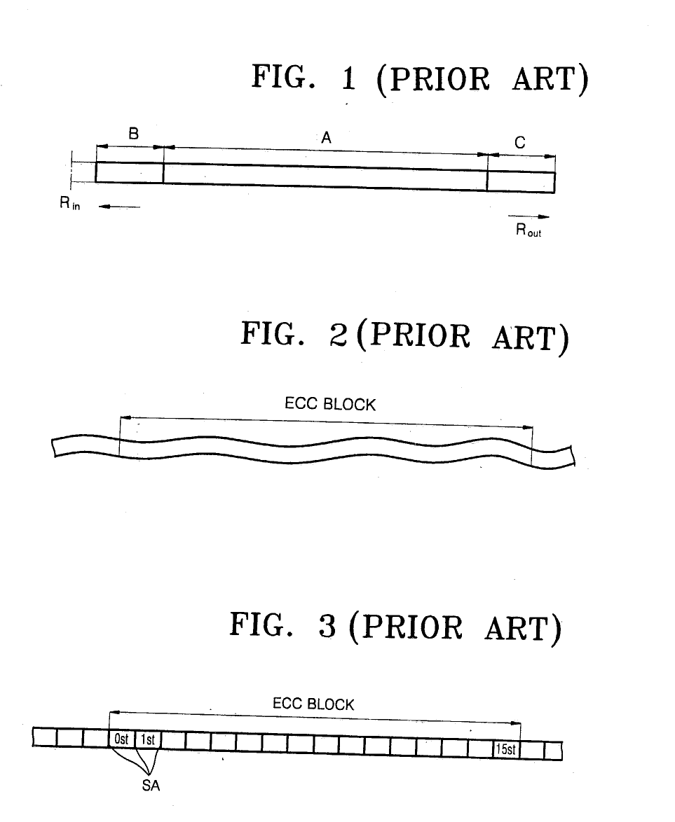

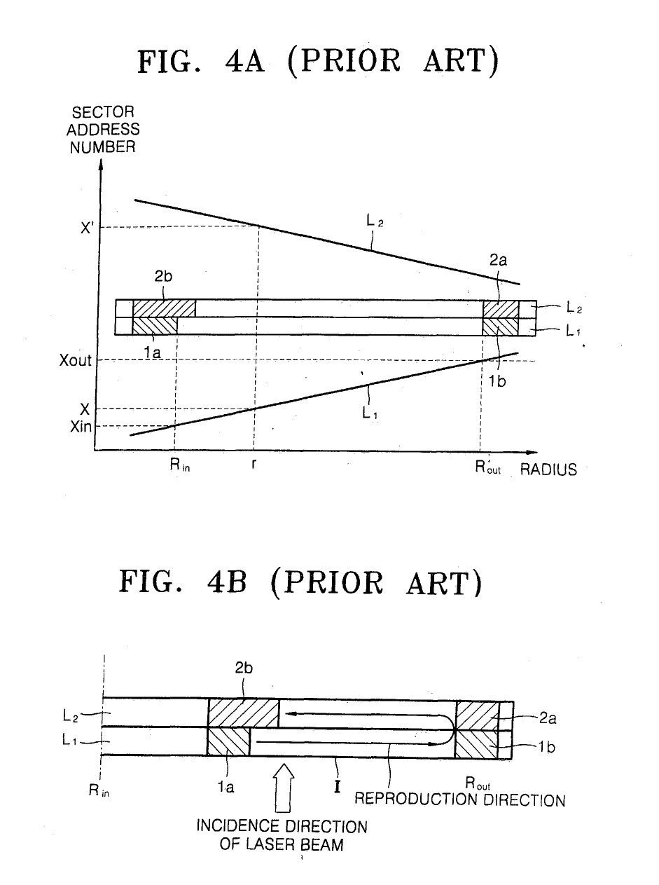

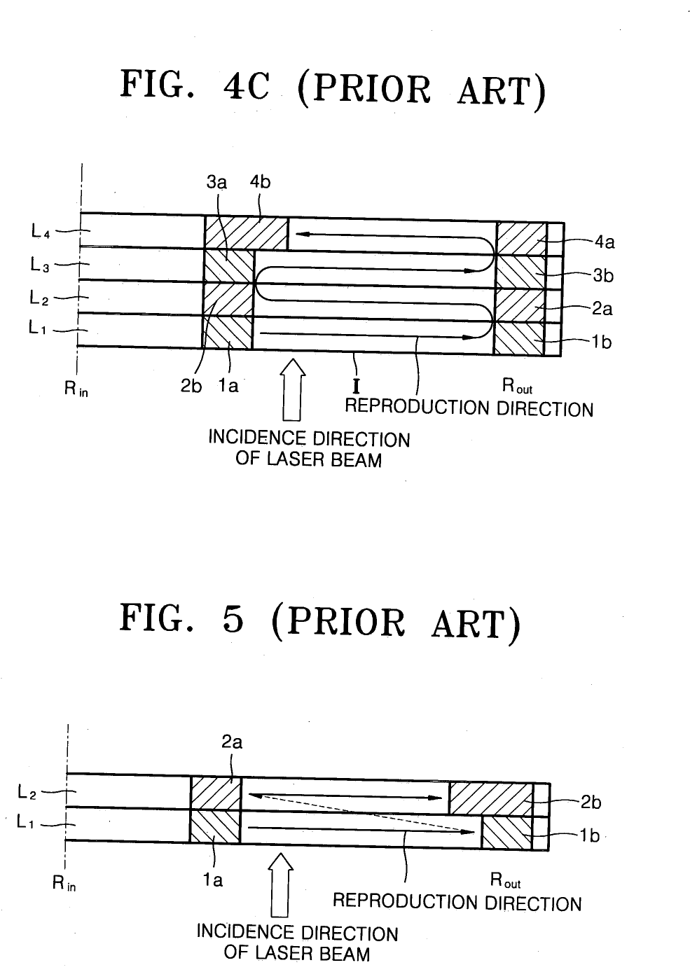

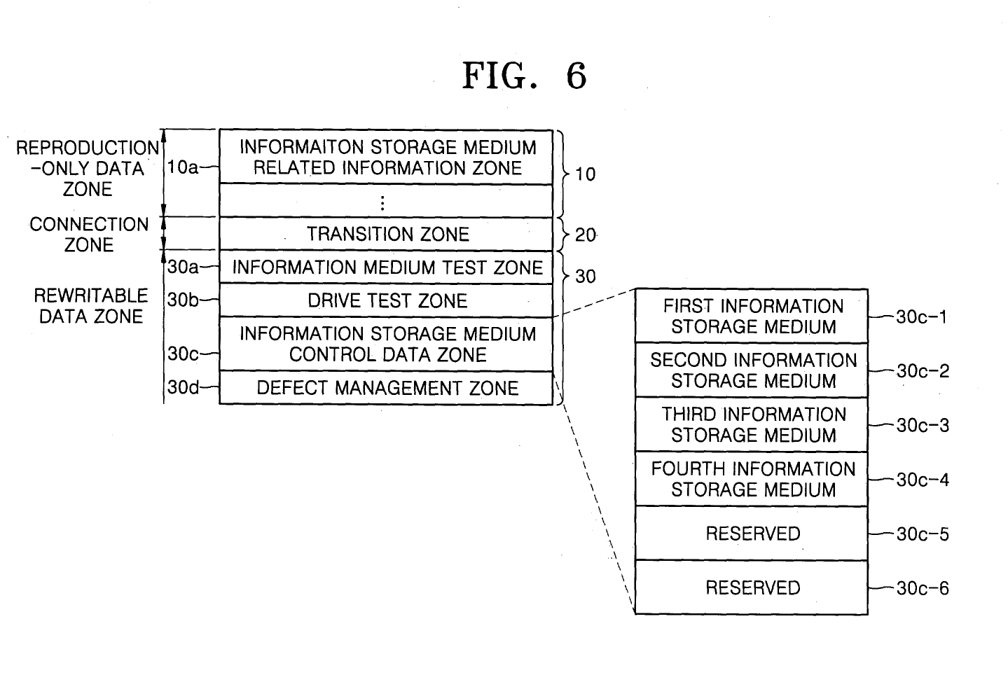

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

It is understood that an information storage medium according to the present invention may be a recordable or reproduction-only storage medium. Furthermore, a recordable information storage medium may include a single information storage layer or a plurality of information storage layers. Each information storage layer may include a lead-in area, a user data area, and a lead-out area.

FIG. 6 illustrates that at least one of a lead-in area and a lead-out area of a recordable information storage medium includes a reproduction-only data zone 10, a rewritable data zone 30, and a connection zone 20, which connects the reproduction-only data zone 10 to the rewritable data zone 30.

The reproduction-only data zone 10 stores basic information about the information storage medium in a form of pits or a high frequency groove wobble. The reproduction-only data zone 10 includes an information storage medium related information zone 10a where the size, version number, and recording conditions of the information storage medium are recorded.

The connection zone 20 may include a transition zone to transition between the reproduction-only data zone 10 and the rewritable data zone 30. Alternatively, the connection zone 20 may include a mirror zone or a wobble groove zone.

The rewritable data zone 30 may include an information storage medium test zone 30a, a drive test zone 30b, an information storage medium control data zone 30c, and a defect management zone 30d. The information storage medium control data zone 30c includes at least one information storage medium control region to record information about control of the information storage medium. In FIG. 6, the information storage medium control data zone 30c includes first through fourth information storage medium control regions 30c-1, 30c-2, 30c-3, and 30c-4. The information storage medium control data zone 30c may further include at least one reserved area, for example, reserved areas 30c-5 and 30c-6, to record other information. For example, data may be recorded in the user data in a form of a groove wobble.

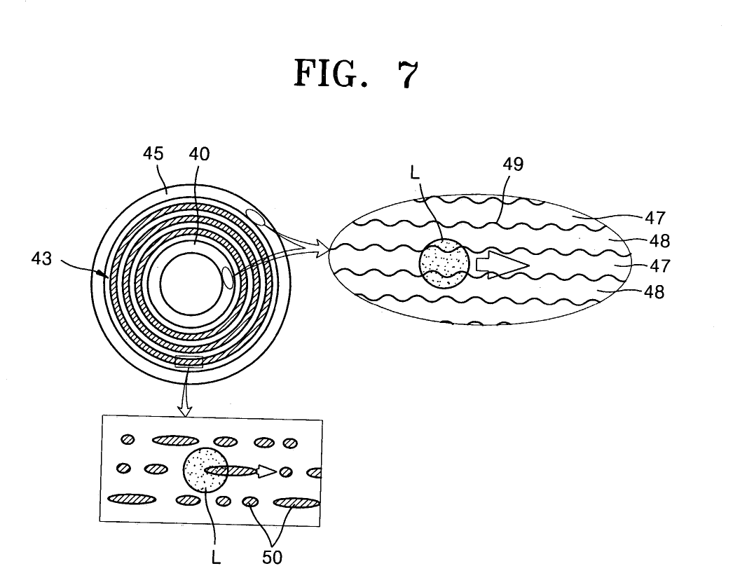

FIG. 7 illustrates that a reproduction-only information storage medium includes at least one information storage layer which includes a lead-in area 40, a user data area 43, and a lead-out area 45. The lead-in area 40 and/or the lead-out area 45 record reproduction-only data such as information about the information storage medium, and the user data area 43 records reproduction-only user data.

Groove tracks 47 and land tracks 48 are alternately formed on both the lead-in area 40 and the lead-out area 45. The reproduction-only data, such as information about the information storage medium, is recorded on both sidewalls of each of the groove tracks 47 or land tracks 48 in a form of a high frequency groove wobble 49. An area where data has been recorded as the high frequency groove wobble 49 is referred to as a high frequency data zone.

The user data is recorded as pits 50 when, for example, the information storage medium is manufactured. Such an information storage medium corresponds to a hybrid disk and requires different channels for reproduction. In a recordable information storage medium, reproduction only data in a lead-in area is reproduced using a push-pull channel, and user data is reproduced using a sum channel. Similarly, in a reproduction-only information storage medium, a lead-in area can be reproduced using a push-pull channel, and a user data area can be reproduced using a sum channel. In this respect, consistency between recordable information storage media and reproduction-only information storage media can be obtained.

Methods of detecting information about a user data area, for example, information about whether there is only one or a plurality of information storage layers, or information about from which information storage layer is data reproduced, from a recordable or reproduction-only information storage medium having the above-described structure will now be described.

Generally, physical addresses are recorded to every basic recording unit of a user data area where data is recorded.

An information storage medium according to an embodiment of the present invention includes at least one information storage layer.

Where the information storage medium includes two information storage layers, physical address Nos. 0 to 30000 are recorded in a first information storage layer, and physical address Nos. 30001 to 60000 are recorded in a second information storage layer. Accordingly, the number of information storage layers included in an information storage medium can be detected using these physical addresses. For example, every time a pickup approaches an optical disk to record/reproduce data from the optical disk, physical addresses of individual basic recording areas are read. Here, where the read physical addresses fall within the range of 0 to 30000, it is recognized that corresponding basic recording areas belong to the first information storage layer, and on the other hand, where the read physical addresses fall within the range of 30001 to 60000, it is recognized that corresponding basic recording areas belong to the second information storage layer.

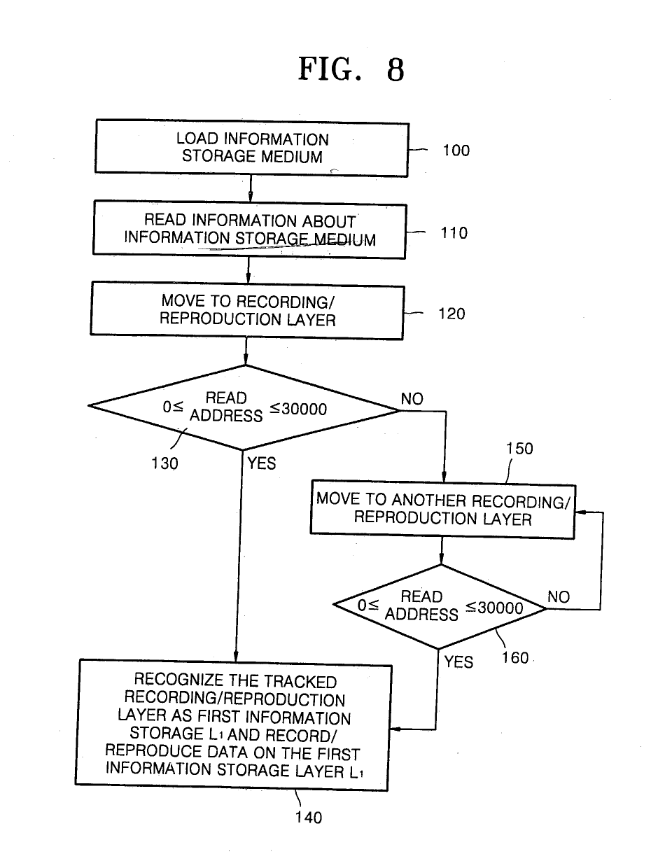

FIG. 8 shows a flowchart illustrating a method of searching for a first information storage layer L₁ of an information storage medium having at least one information storage layer, according to the present invention. In operation 100, the information storage medium is loaded on a turntable of an optical recording/reproduction drive. In operation 110, an optical pickup device reads information about the information storage medium from the information storage medium. In operation 120, the optical pickup device moves to a recording/reproduction layer to, for example, record data to or reproduce data from the recording/reproduction layer. At this time, the optical pickup device accesses the recording/reproduction layer to focus and track the same, thereby reading addresses from the tracked recording/reproduction layer. In operation 130, it is determined whether the read addresses belong to a predetermined group of addresses. As described above, where it is determined that the read addresses fall within a range of 0 to 30000, the tracked recording/reproduction layer is recognized as, for example, the first information storage layer L₁, and accordingly, data is recorded to or reproduced from the first information storage layer L₁, in operation 140.

However, where it is determined that the reproduced addresses do not fall within the range of 0 to 30000, an optical spot formed by the optical pickup device is focused on another layer, in operation 150. In operation 160, the process of determining whether read addresses belong to a predetermined group of addresses is repeated. That is, where it is determined that read addresses belong to a predetermined group of addresses correspond to a layer of interest, recording or reproduction is performed on that layer. Otherwise, addresses of another layer are checked. By repeating these processes, the layer of interest, for example, the first information storage layer L₁ can be found.

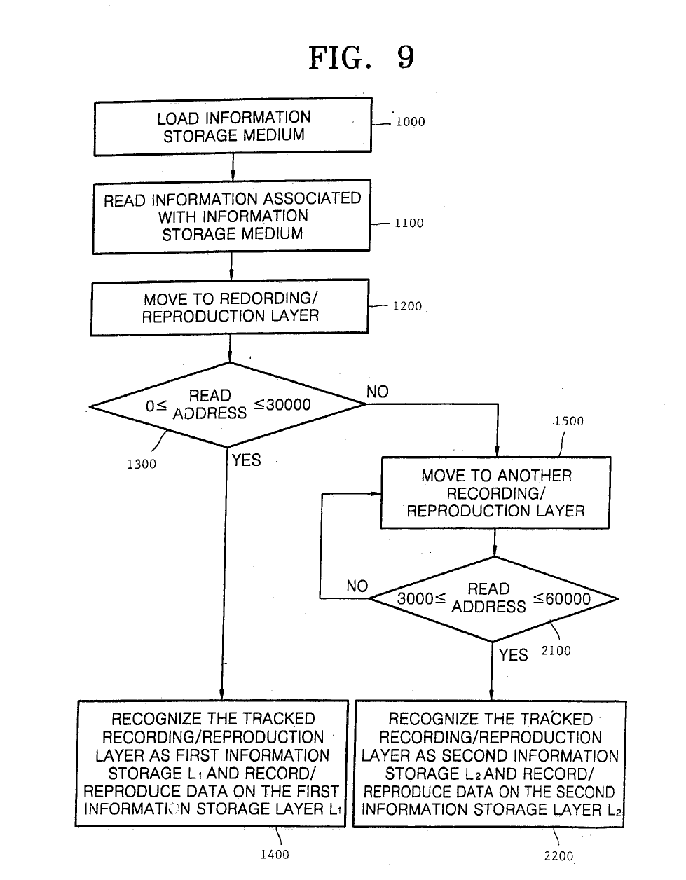

FIG. 9 shows a flowchart illustrating a method of searching for first and second information storage layers L₁ and L₂ of an information storage medium having a plurality of storage layers, according to present invention. In operation 1000, the information storage medium is loaded on a turntable of an optical recording/reproduction drive. In operation 1100, an optical pickup device reads information about the information storage medium from the information storage medium. In operation 1200, the optical pickup device moves to a recording/reproduction layer to, for example, record data to or reproduce data from the recording/reproduction layer. At this time, the optical pickup device accesses the recording/reproduction layer to focus and track the same, thereby reading addresses from the tracked recording/reproduction layer. In operation 1300, it is determined whether the read addresses belong to a predetermined group of addresses. As described above, where it is determined that the read addresses fall within the range of 0 to 30000, the tracked recording/reproduction layer is recognized as, for example, the first information storage layer L₁, and accordingly, data is recorded to or reproduced from the first information storage layer L₁, in operation 1400.

However, where it is determined that the read addresses do not fall within the range of 0 to 30000, an optical spot formed by the optical pickup device is focused on another layer, in operation 1500. In operation 2100, it is determined whether read addresses belong to a predetermined group of addresses, for example, a group of addresses numbered 30001 to 60000. Where it is determined that the read addresses fall within the range of 30001 to 60000, the tracked recording/reproduction layer is recognized as, for example, the second information storage layer L₂, and accordingly, data is recorded to or reproduced from the second information storage layer L₂, in operation 2200.

In the above, a method of searching for particular layers and recording/reproducing with respect to the same have been described. In the case of an information storage medium having three or more information storage layers, it is understood that the above methods can be applied to locate one or more desired storage layers for operations including recording and/or reproducing.

According to an aspect of the present invention, another method of detecting information about a user data area is provided as follows. That is, information about a user data area, for example, information about layers, is recorded in at least one of two areas right before and after a basic recording unit where data is recorded. The basic recording unit having the data can be a physical cluster, an error correction code (ECC) block, a sector, a frame, or the like, and its capacity is not restricted.

FIG. 10 shows an ECC block of an information storage medium according to the present invention. The ECC block includes a plurality of sectors, and information about a user data area is recorded on an inside and/or outside of the ECC block to serve as address information. Accordingly, the information about the user data area recorded on the inside and/or outside of the ECC block is the address of the ECC block. The ECC block address may include layer information that represents the number of information storage layers included in the information storage medium. In other words, the layer information is recorded using an address.

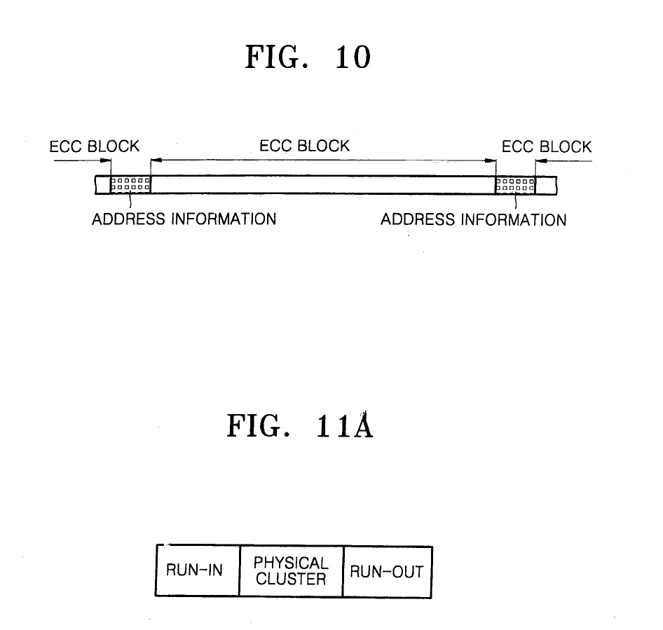

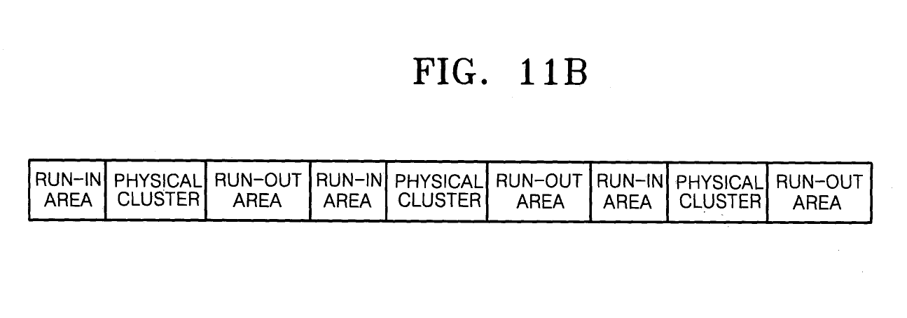

FIG. 11A shows a case in which data is recorded in a physical cluster of an information storage medium according to the present invention. Referring to FIG. 11A, a run-in area and a run-out area are provided right before and after the physical cluster, respectively, to record additional data. FIG. 11B shows a sequence of the physical clusters. Here, information about a user data area, for example, layer information, can be recorded in at least one of the run-in and run-out areas another embodiment of the present invention includes at least two information storage layers, and stores layer information about each of the information storage layers in at least one of a run-in area and a run-out area so as to record the layer information in different patterns for different layers.

For example, in information storage media having two information storage layers, a first information storage layer L₁ can be formed in a mark (or pit)-space interval pattern of 5T/5T/5T/5T, while a second information storage layer L₂ can be formed in a mark (or pit)-space interval pattern of 8T/8T/8T/8T. Such different consecutive patterns of identical intervals enable the number of information storage layers to be recognized.

According to another aspect, the first information storage layer L₁ can be formed in a mark (or pit)-space interval pattern of 2T/9T/2T/9T, while the second information storage layer L₂ can be formed in a mark (or pit)-space interval pattern of 9T/2T/9T/2T. Hence, the number of information storage layers can be recognized by randomly combining different-sized intervals in different patterns.

Accordingly, information storage layers can be easily detected by differently patterning at least one of two areas right before and after a basic recording unit of a user data area, for example, a run-in area and a run-out area. The basic recording unit can be, for example, a physical cluster, an ECC block, a sector, a frame, or the like.

As described above, in an information storage medium according to the present invention and a method of recording and/or reproducing data thereon, even where a user data area has no groove wobbles, data can be effectively recorded and/or reproduced using the methods described above, so as to provide information about the user data area, for example, information about whether the information storage medium includes a single layer or a plurality of layers, or information about information storage layers. The present methods are effectively applied to reproduction-only information storage media having no groove wobbles, enabling reliable data reproduction. Also, information about a user data area can be recorded on recordable information storage media using the present methods in addition to a method of recording data on a groove wobble.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium comprising a user data area, wherein information about the user data area, where user data is recorded, is recorded in at least one of an area right before and an area right after a basic recording unit of the user data area.

2. The information storage medium of claim 1, wherein the basic recording unit of the user data area is one of a physical cluster, an error correction code (ECC) block, a sector, and a frame.

3. The information storage medium of claim 2, wherein the information about the user data area is recorded in at least one of a run-in area and a run-out area that are right before and after the physical cluster, respectively.

4. The information storage medium of claim 3, wherein:
the information storage medium has at least two information storage layers, and
the information about the user data area is recorded in at least one of the area right before and the area right after the basic recording unit of the user data area in different patterns for the different information storage layers.

5. The information storage medium of claim 3, wherein the information about the user data area is recorded using addresses.

6. The information storage medium of claim 3, wherein the information about the user data area is storage layer information.

7. The information storage medium of claim 6, wherein the storage layer information is recorded using addresses.

8. The information storage medium of claim 1, wherein:
the information storage medium has at least two information storage layers, and
the information about the user data area is recorded in at least one of the area right before and the area right after the basic recording unit of the user data area in different patterns for the different information storage layers.

9. The information storage medium of claim 1, wherein the information about the user data area is recorded using addresses.

10. The information storage medium of claim 1, wherein the information about the user data area is storage layer information.

11. The information storage medium of claim 10, wherein the storage layer information is recorded using addresses.

12. A method of recording and/or reproducing data on an information storage medium having a user data area, the method comprising:
reading information about the user data area, where user data is recorded, from at least one of an area right before and an area right after a basic recording unit of the user data area; and
recording and/or reproducing the data based on the information about the user data area.

13. The method of claim 12, wherein the basic recording unit of the user data area is one of a physical cluster, an error correction code (ECC) block, a sector, and a frame.

14. The method of claim 13, wherein the information about the user data area is recorded in at least one of a run-in area and a run-out area that are right before and after the physical cluster, respectively.

15. The method of claim 13, wherein:
the information storage medium has at least two information storage layers, and
the information about the user data area is recorded in at least one of the area right before and the area right after the basic recording unit of the user data area in different patterns for the different information storage layers.

16. The method of claim 13, wherein the information about the user data area is recorded using addresses.

17. The method of claim 13, wherein the information about the user data area is storage layer information.

18. The method of claim 17, wherein the storage layer information is recorded using addresses.

19. The method of claim 12, wherein:
the basic recording unit of the user data area is a physical cluster, and
the information about the user data area is recorded in at least one of a run-in area and a run-out area that are right before and after the physical cluster, respectively.

20. The method of claim 12, wherein:
the information storage medium has at least two information storage layers, and
the information about the user data area is recorded in at least one of the area right before and the area right after the basic recording unit of the user data area in different patterns for the different information storage layers.

21. The method of claim 12, wherein the information about the user data area is recorded using addresses.

22. The method of claim 12, wherein the information about the user data area is storage layer information.

23. The method of claim 22, wherein the storage layer information is recorded using addresses.

24. The information storage medium of claim 1, wherein the information storage medium is a recordable information storage medium.

25. The information storage medium of claim 1, wherein the information storage medium is a reproduction-only storage medium.

26. The information storage medium of claim 1, wherein the information storage medium is one of recordable and reproduction-only optical discs.

27. The information storage medium of claim 2, wherein the information about the user data area is recorded using one or more addresses of the ECC block.

28. The information storage medium of claim 3, wherein the information storage medium is a reproduction-only storage medium.

29. The information storage medium of claim 3, wherein each of the information storage layers includes a lead-in area, a lead-out area and the user data area.

30. The information storage medium of claim 4, wherein the different patters are one of different consecutive patterns of identical intervals and different patterns of different sized intervals.

31. The information storage medium of claim 8, wherein the different patters are one of different consecutive patterns of identical intervals and different patterns of different sized intervals.

32. A method of operating a storage medium having a user data area, the method comprising:
accessing information about the user data area, where user data is recorded, from at least one of an area right before and an area right after a basic recording unit of the user data area; and
operating the storage medium based on the accessed information.

33. The method of claim 32, further comprising recognizing a layer of the storage medium based on the accessed information, wherein the operating of the storage medium includes recording and/or reproducing data with respect to the layer.

34. The method of claim 33, wherein the recognizing of the layer comprises recognizing the layer in response to the accessed information belonging to a predetermined group of addresses.

35. The method of claim 32, further comprising identifying a desired layer of the storage medium based on ranges to which the accessed information belongs.

36. The method of claim 35, wherein the identifying of the desired layer comprises:
recognizing a storage layer of the storage medium as the desired layer in response to the accessed information belonging to a predetermined range; and
in response to the accessed information not belonging to the predetermined range, accessing another storage layer of the storage medium so as to determine whether accessed information thereof belongs to the predetermined range.

37. The method of claim 36, wherein the operating of the storage medium includes recording and/or reproducing data with respect to the desired layer.

38. The method of claim 32, further comprising identifying storage layers of the storage medium, wherein the identifying of the storage layers comprises:
recognizing a first layer of the storage layers in response to the accessed information belonging to a first predetermined range;
in response to the accessed information not belonging to the first predetermined range, accessing a second layer of the storage layers so as to determine whether accessed information thereof belongs to a second predetermined range;
recognizing the second layer of the storage layers in response to accessed information thereof belonging to the second predetermined range; and
in response to the accessed information of the second layer not belonging to the second predetermined range, accessing another layer of the storage layers so as to determine whether accessed information thereof belongs to the second predetermined range.
